(19) United States
(12) Patent Application Publication
(10) Pub. No.: US 2006/0188761 A1
(43) Pub. Date: Aug. 24, 2006

(54) Fuel cell power plants

(76) Inventors: Christopher J. O'Brien, Somerville, MA (US); Michael Yurievich Leshchiner, Needham, MA (US); James C. Cross III, Melrose, MA (US); Olga Polevaya, Needham, MA (US); Darryl Pollica, Melrose, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/323,336

(22) Filed: Dec. 30, 2005

Related U.S. Application Data
(60) Provisional application No. 60/646,701, filed on Jan. 25, 2005.

(51) Int. Cl. H01M 8/04; H01M 8/06

(52) U.S. Cl. 429/19; 429/26; 429/34; 429/20; 429/24; 429/13

(57) ABSTRACT

A fuel cell power plant comprises a fuel processor and a fuel cell stack. The fuel cell stack has cooling water directly passing through its anode or cathode compartments. The high humidity cathode exhaust may be used to provide oxygen and steam for the autothermal reaction in the fuel processor, and may also be used in a combustor to generate heat and combustion exhaust. The combustion exhaust can be used to drive a turbine to generate power.

### RELATED APPLICATION

This application claims the benefit of U.S. Provisional Application No. 60/646,701, filed on Jan. 25, 2005. The entire teachings of the above application are incorporated herein by reference.

### FIELD OF THE INVENTION

The field of invention pertains to a system that combines a fuel processor that converts fuels to hydrogen-containing reformate and fuel cell stacks that uses the reformate or hydrogen to produce electricity.

### BACKGROUND OF THE INVENTION

Fuel cells are electrochemical devices where fuels and oxygen can react to generate electricity. This mode of power generation enjoys benefits such as high efficiency and flexibility in the power output, for instance, from 1 kW to hundreds of kilowatts. Among many types of fuel cells, the polymer electrode membrane fuel cell (PEMFC) uses hydrogen or hydrogen-containing reformate as fuel. A fuel processor converts hydrocarbon fuels to reformate through fuel reforming. Reformate typically contains hydrogen, water, carbon dioxide, carbon monoxide, and nitrogen. For PEM fuel cells, carbon monoxide is a poison to the catalysts on the membrane electrode and should generally be limited to 100 ppmv or lower. In a typical operation, reformate passes through the anode compartments in a fuel cell while an oxidant stream passes through the cathode compartment, the oxygen in the oxidant stream and the hydrogen in the reformate react on the membrane electrode assembly (MEA) and generates electricity, water and heat.

A fuel processor and a fuel cell stack are the main components in a power plant, the other parts includes balance of plant components (e.g. pumps, compressors, etc.) and power electronics. Each component in the power plant has characteristic efficiency, for instance, a typical AC to DC power converter has an efficiency of 90%, a typical electric compressor has an efficiency of 70% or less, and the fuel processor has a typical thermal efficiency of 60%. However, the efficiency of the power plant as a system is not merely the result of multiplication of the typical component efficiencies, a clever process design enables optimal usage of waste energy from the components within the system to maximize the system efficiency. The current invention relates to several novel designs for a fuel processor-fuel cell power plant system.

### SUMMARY OF THE INVENTION

According to one aspect of this invention, a power plant comprises a fuel cell that is cooled by cooling water that is directly injected into the cathode compartment of the fuel cell. The high-humidity cathode exhaust is then utilized as the oxidant stream for autothermal reforming reaction in the fuel processor.

According to another aspect of this invention, a power plant comprises a fuel cell that is cooled by water injected that is directly into its anode or cathode compartments, or both. The high humidity cathode exhaust and/or anode exhaust is then combusted in a combustor; the combustion exhaust is used to drive a power generating turbine.

According to another aspect of this invention, a fuel processor is integrated with a membrane separation module or a pressure swing adsorption module which can separate the reformate into high purity hydrogen stream and a hydrogen depleted stream. The high purity hydrogen is used as fuel for the fuel cell.

According to another aspect of this invention, the fluid in the power plant is mobilized by a blower installed in the exhaust gas line.

According to another aspect of this invention, the fuel processor has a section for autothermal reaction and a section for steam reforming. Only one section may be in operation when the demand for power is low, while both sections can be in operation when the demand for power is high.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings do not include all the components needed in a fuel cell power plant, emphasis instead being placed upon illustrating the principles of the invention.

FIG. 1 is a schematic of a fuel cell power plant according to one embodiment of the invention;

FIG. 2 is a schematic of a second embodiment of a fuel cell power plant;

FIG. 3 is a schematic of a third embodiment of a fuel cell power plant;

FIG. 4 is a schematic of a fourth embodiment of a fuel cell power plant; and

FIG. 5 is a schematic of a fifth embodiment of a fuel cell power plant.

### DETAILED DESCRIPTION OF THE INVENTION

A description of preferred embodiments of the invention follows.

The electric efficiency (e.g. energy in electricity/power of consumed hydrogen) of a PEM fuel cell is in the range of 50%-65%, which means that thermal energy generated in the fuel cell operation equals to 35%-50% of the power of hydrogen consumed. The reaction heat is typically removed by running coolant through cooling cells in a fuel cell stack. A cooling cell is typically sandwiched between an anode and a cathode cell. The heat generated in the cells are transferred to the coolant and removed away from the fuel cell stack. Another method to remove reaction heat is to directly inject cooling water into the anode or cathode cells. Water is heated in the cells, it vaporizes, and its temperature rises to substantially equal to fuel cell operating temperature. The anode or cathode exhaust from a well designed direct water injection (DWI) fuel cell stack is therefore saturated with water vapor at this operating temperature. Since a PEM fuel cell operates at 70 degC.-80 degC., the dew point of the cathode or anode exhaust is at the same temperature, which contains 20%-31% of water vapor. Compared with fuel cells with separate coolant loop, the DWI fuel cell stacks has a cathode and/or an anode exhaust stream that contains more thermal energy due to the presence of additional water vapor in the stream. If the anode or cathode exhaust is combusted and the combustion exhaust is used to drive a turbine, this additional thermal energy from the water vapor can be transferred to turbine shaft energy and put into use. If the fuel processor uses an autothermal reforming process, the high-humidity cathode exhaust may provide oxygen as well as steam for the ATR reaction and therefore reduces or eliminates the need for equipment and energy to vaporize water.

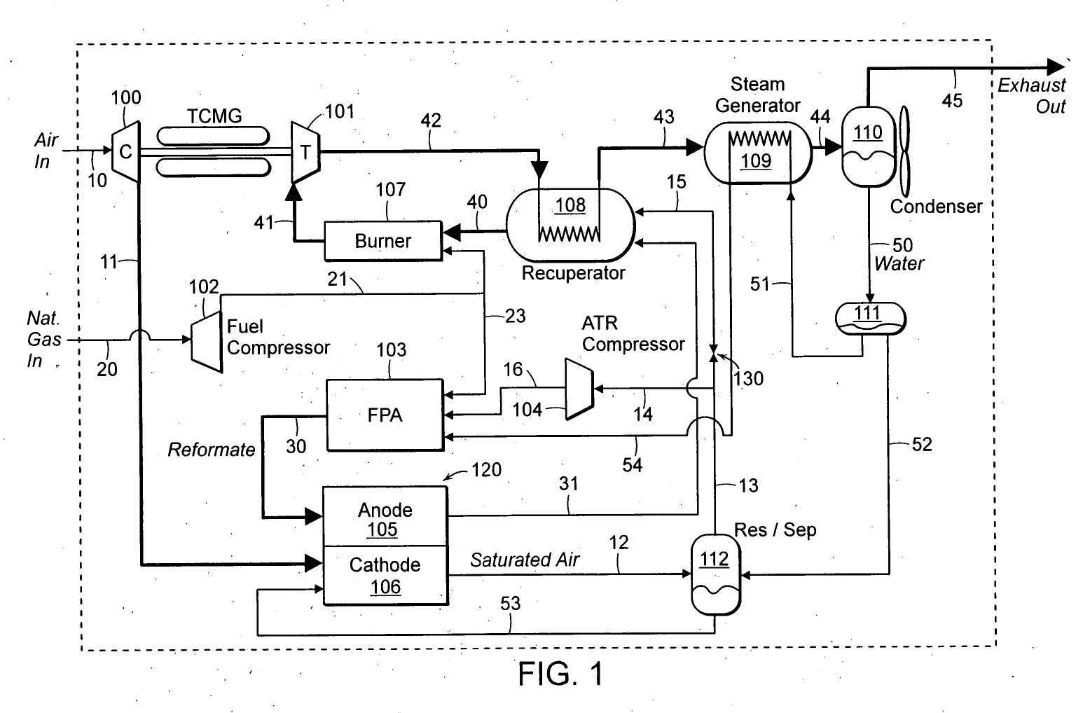

FIG. 1 illustrates a preferred embodiment of this invention. Air stream 10, after being compressed in compressor 100, is fed to the cathode of side of the fuel cell stack. Cathode water 53 from water reservoir 112 is injected to the cathode side of the fuel cell. Inlet fuel stream 20 is first compressed in a compressor (or pump) 102. The high pressure fuel stream 21 is then split into stream 22, which enters the burner to be combusted, and stream 23, which enters the fuel processor 103 for fuel reforming. The fuel processor 103 typically includes fuel reforming section such as ATR and steam reforming (SR) section, as well as water gas shift (WGS) and preferential oxidation (PrOx) sections to reduce CO content to 100 ppmv or lower. The reformate stream 30 exits the fuel processor 103 and enters the anode 105 of the fuel cell stack 120. Electricity is produced in the fuel cell to supply a load (not shown), while the cathode exhaust stream 12 is saturated with water. The cathode exhaust stream 12 enters a water reservoir to drop out liquid water and becomes stream 13. A portion of stream 13 proceeds to a recuperator 108 as stream 15. Stream 14, which contains cathode exhaust, may be optionally compressed in a compressor 104 and fed into the reformer as an oxidant stream 16. The split ratio between stream 14 and stream 15 is controlled by a valve 130 so that the air fuel ratio (indicated by Phi value) and the steam to carbon ratio in the fuel processor 103 is maintained at a predetermined value. Simulation results indicate that if the fuel cell stack 120 is operated at 75 degC. at 0.65 volt per cell, the steam to carbon ratio of the inlet mixture to the fuel processor is at 4 when the phi value is 4. The anode exhaust 31 also enters the recuperator 108. The function of the recuperator 108 is to transfer heat from the combustion exhaust with the anode and cathode exhaust. The superheated mixture of the anode and cathode exhaust 40 enters the catalytic combustor 107, in which they are combusted to form combustion exhaust 41. Optionally, additional air (not shown) or fuel stream 22 can be added to increase the energy release in the combustor 107. Combustion exhaust 41 then drives a turbine 101. The turbine 101 can be coupled to the compressor 100 or to another power outlet. The exhaust stream 42, after being cooled in the recuperator 108 and further cooled in the steam generator 109, drops out water in the condenser 110 and exits the system as stream 45. Water stream 50 from the condenser 110 enters the water reservoir 111 and from which may supply the steam generator 109 as stream 51 which becomes steam stream 54 to supply the fuel processor. Alternatively or in addition, the water stream 52 may also supply reservoir 112. Simulation indicates that this process, which utilizes high-humidity cathode air stream as ATR oxidant and burner oxidant, may increase the system efficiency 2%-5%.

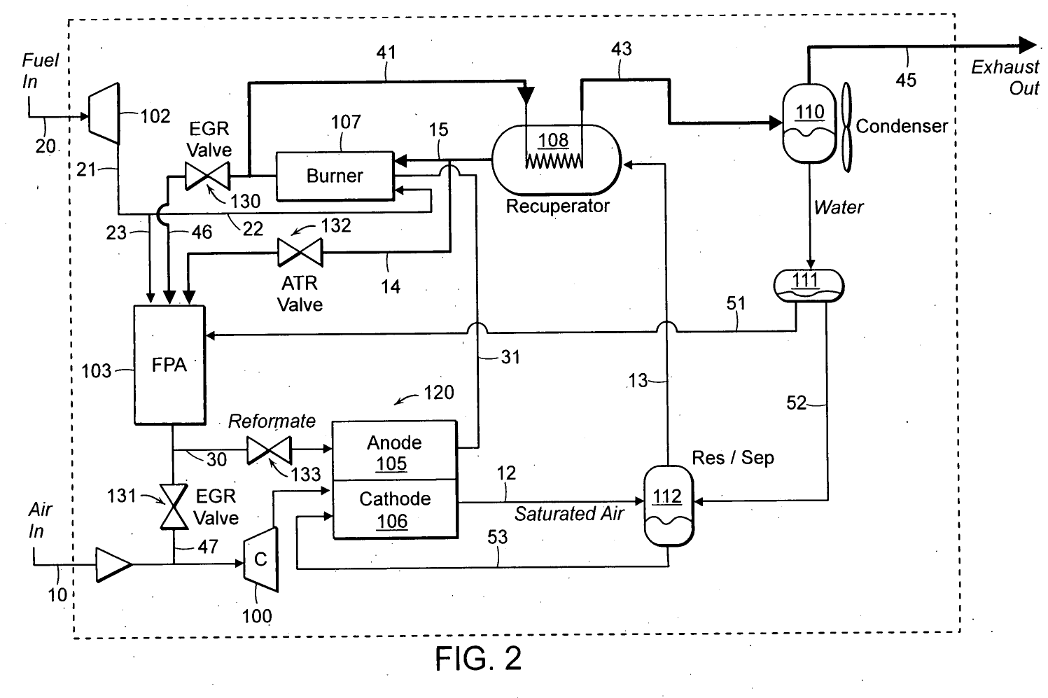

An alternative process is illustrated in FIG. 2. This system is designed to operate at a low pressure and therefore the burner exhaust is not used to drive a turbine. The functions of components in the power plant are similar to those in FIG. 1 and are given the same number if possible. FIG. 2 also indicates how the fuel processor 103 may be warmed up at the system startup—it is heated by high temperature exhaust from the combustion chamber 107. A high temperature exhaust gas recirculation (EGR) valve 130 is installed on stream 46, and another EGR valve 131 is installed on the reformate exit line. A third valve 132 is installed on stream 14, and a forth valve 133 is installed on stream 30. During startup, EGR valves 130 and 131 are open and valves 132 and 133 are closed. The hot combustion exhaust 46 passes 130 and enters the fuel processor 103. The same gas stream, after releasing heat to the fuel processor 103, exits through 131 as stream 47. The stream 47 may be vented or be combined with air stream 10 through compressor 100 to re-enter the system. Once the fuel processor 103 reaches a predetermined operation temperature, valves 130 and 131 are closed and valves 132 and 133 are open. Humidified air stream 14 enters the fuel processor through valve 132 and the product reformate stream 30 enters the anode 105 of the fuel cell 120. The operation is otherwise similar to the power plant described in FIG. 1.

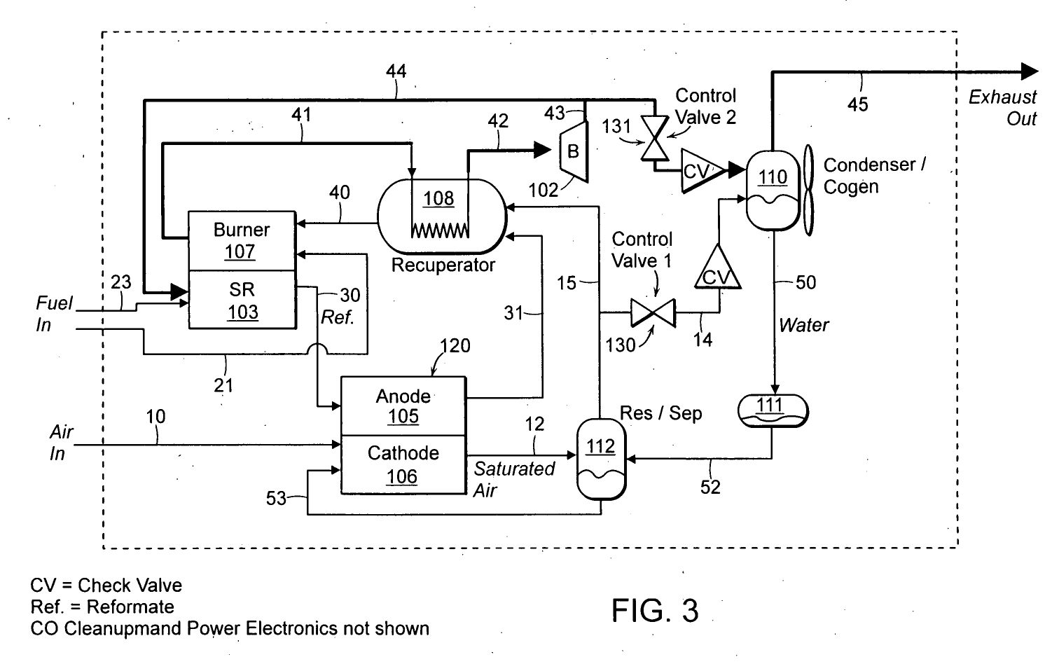

FIG. 3 describes a power plant which uses steam reforming of fuels in the fuel processor. The fluids in the system are mobilized by an induction force created by a blower 102 installed in the combustion exhaust line 42. In this embodiment, fuel stream 23 supplies fuel for steam reforming; optionally fuel stream 21 is introduced to the combustor 107 to be combusted together with stream 40 (a combination of cathode exhaust 15 and anode exhaust 31) to supply the heat to sustain the steam reforming reaction. The fuel cell stack 120 operates as a direct water inject fuel cell, and a large amount of steam is carried in cathode exhaust 15 and is therefore also present in streams 40, 41, 42, and 43. Stream 43 is split so that a portion of the stream (stream 44) is introduced to the fuel processor to provide steam for the steam reforming reaction. The amount of the flow in 44 should satisfy the steam to carbon ratio requirement in the fuel processor 103. This is accomplished by controlling valve 131, which splits stream 43 into stream 44 and 45. It is also important the stream 44 does not contain oxygen, which requires that the oxygen contained in stream 15 is fully consumed in burner 107. Controlling the flow rate of stream 15 can regulate the amount of oxygen available in the burner. It is accomplished by adjusting control valve 130 to vent steam 14 to the condenser 110. In practice, an oxygen sensor may be installed on stream 44 which is linked to the control mechanism of valve 130. The blower 102 creates an induction force to induce air stream 10 and optionally fuel streams 21 and 23 into the system and therefore eliminates the need for a fuel compressor (or pump) and an air compressor in the system

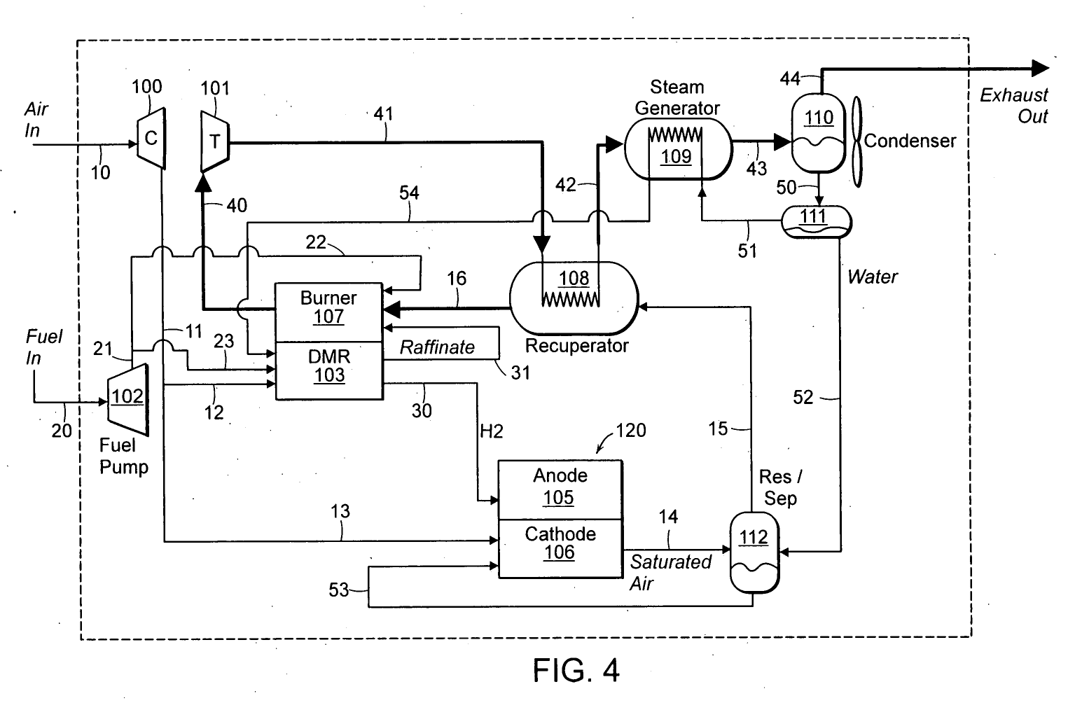

A fourth embodiment of the power plant is described in FIG. 4. This embodiment is similar to the one described in FIG. 1. The difference is that a differential membrane reactor (DMR) is used in the fuel processor 103. Hydrogen has high permeability to some metals such as palladium; while other species in the reformate, such as water and carbon dioxide, are not permeable. This property can be used to separate hydrogen from reformate. Typically, the reformate is kept at a high pressure on one side of the membrane and a low pressure on the other side. The pressure gradient across the membrane is the driving force to push hydrogen to the other side of the membrane. The product hydrogen, stream 30 in this case, is of high purity (e.g. contains 99.99% hydrogen) and may be directly used in a fuel cell stack 120 in a dead end mode, meaning without an anode exhaust gas stream. The hydrogen-depleted raffinate (stream 31 in this case) is sent to the combustor 107 to be consumed. Optionally, an anode exhaust stream can still be provided, which may also be sent to the combustor 107 to be consumed. The oxidant in the combustor 107 is the high-humidity cathode exhaust stream 16. The combustion exhaust stream 40 may be used to drive a turbine 101 to convert thermal energy to mechanical energy. The reaction in the DMR may be an autothermal reaction; in which case air stream 12 and steam 54 must be supplied to the DMR. Optionally, cathode exhaust may also be used to supply oxidant to the DMR (not shown in FIG. 4). The reaction may also be steam reforming, which does not require an oxidant but still requires steam stream 54.

Alternatively, a pressure swing separation (PSA) module may be incorporated in the fuel processor. The PSA module uses an adsorbent that adsorbs carbon monoxide at a high pressure and release it at a low pressure. In practice, the PSA also produce a hydrogen stream that is substantially free of carbon monoxide and a side stream which is depleted of hydrogen. Therefore, a PSA module can be used in place of a membrane separation module with minor changes to the power plant.

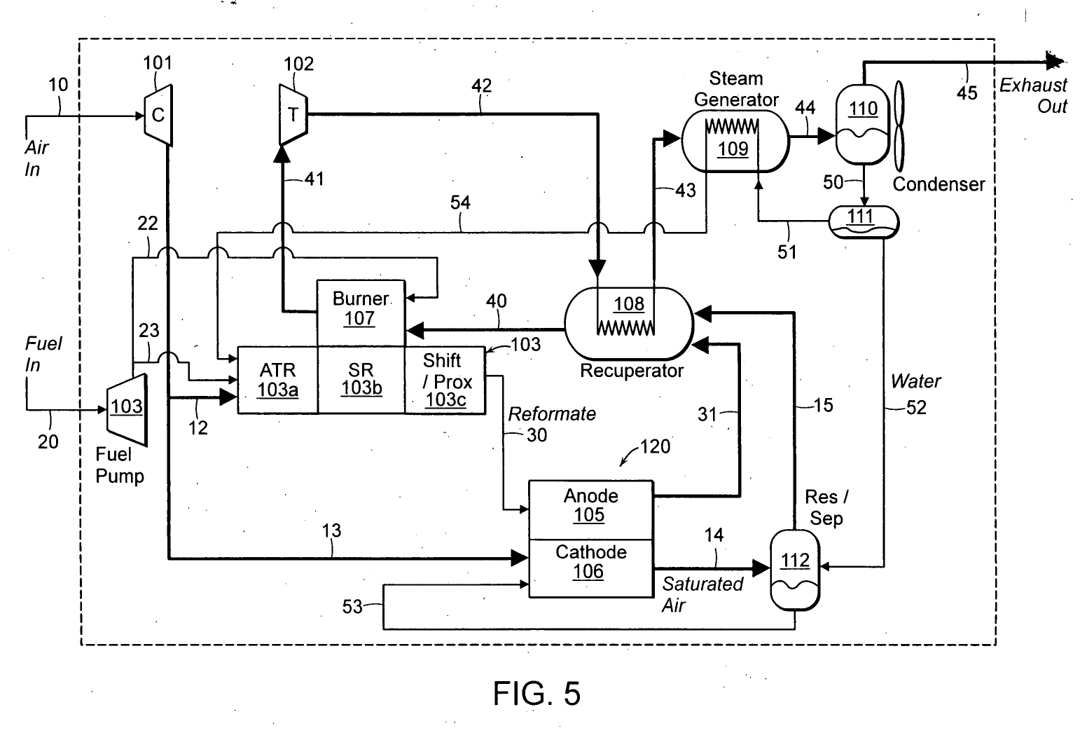

A fifth embodiment of the power plant is shown in FIG. 5. This power plant differs from other designs mainly in the configuration and operation of fuel processor 103. This fuel processor consists of both ATR section 103a and SR section 103b (WGS and Prox reaction section 103 C may be common to other fuel processor designs). Since the ATR reaction may not need an external heat source, it is usually fast to startup, and the reactor may be small. On the other hand, since steam reforming generally needs external heat supplied by the combustion of fuel, the SR reactor is larger and the startup is slower. The design of FIG. 5 combines the ATR 103a and steam reformer 103b in a single fuel processing system. At startup, ATR reaction is used for a fast startup and releases heat to bring the steam reforming zone to the proper operating temperature. During normal operation, if the power demand is low, the steam reformer may be the only reaction zone in operation; if the power demand is high, a combination of ATR and SR can be used. It is understood that some catalysts may be used both under ATR and SR reaction conditions. Therefore, in these systems, the difference between the ATR and SR operation is in whether the oxidant stream 12 is provided. Air 12 can be supplied at startup or power transients to enable ATR reaction while air can be turned off when only SR reaction is desired. The rest of the power plant is similar to that described in FIG. 1.

It should be noted that a DWI (direct water injection) stack may not be required in these power plant designs. A fuel cell with a separate cooling loop alone, or combined with water injection into the cathode exhaust stream downstream, may still produce a humidified cathode stream.

These embodiments exemplify a variety of power plant design options. It is understood that elements in these embodiments may not be exclusive to a particular design and a person of ordinary skill in the art may combine different elements to construct other power plant designs without differing from the principle of this invention.

While this invention has been particularly shown and described with references to preferred embodiments thereof, it will be understood by those skilled in the art that various changes in form and details may be made therein without departing from the scope of the invention encompassed by the appended claims.

What is claimed is:

1. A system for producing electricity from fuel, the system comprising:
a fuel processor, the fuel processor producing hydrogen-containing reformate usable in a fuel cell stack;
sources of fuel, water, and air;
a fuel cell stack, the fuel cell stack having anode and cathode compartments;
a combustor;
means for sending a first portion of an oxygen-containing cathode exhaust stream to the combustor and a second portion of an oxygen-containing cathode exhaust stream to the fuel processor; and
means for condensing water and storing water.

2. The system of claim 1 further comprising means for sending hydrogen-containing anode exhaust to a combustor.

3. The system of claim 1 wherein cooling water is injected directly into the cathode compartments of the fuel cell stack to remove reaction heat.

4. The system of claims 1 wherein cooling water is injected directly into the anode compartments of the fuel cell stack to remove reaction heat.

5. The system of claim 1 wherein cooling water is injected directly into the anode and cathode compartments of the fuel cell stack to remove reaction heat.

6. The system of claim 1 wherein the combustion exhaust from the combustor is used to drive a turbine to generate power.

7. The system of claim 1 wherein the cathode exhaust is the source of oxygen and steam for an autothermal reaction in the fuel processor.

8. The system of claim 1 wherein the fuel processor contains hydrogen purification means to separate high purity hydrogen from reformate.

9. The system of claim 8 wherein the high-purity hydrogen is sent to the fuel cell stack.

10. The system of claim 8 wherein the hydrogen purification means comprises one or more of a hydrogen-selective membrane, a hydrogen-selective pressure swing absorption device, a water gas shift reactor, and a preferential oxidation reactor.

11. The system of claim 1 wherein the air flow in the system is moved by a force of induction created by a blower on an exhaust line from the combustor.

12. The system of claim 1 wherein the combustion exhaust is the source of steam for a steam reforming reaction in the fuel processor.

13. The system of claim 1 wherein the fuel processor comprises both an autothermal reaction zone and a steam reforming reaction zone.

14. The system of claim 1, further comprising at least one exhaust gas recirculation valve for directing an oxidant stream, a fuel stream, and steam to the inlet of the fuel processor during startup.

15. The system of claim 14, wherein the cathode exhaust stream comprises the oxidant and steam to the inlet of the fuel processor during startup.

16. The system of claim 15, wherein the cathode exhaust stream is combusted in combustor before it is sent to the inlet of the fuel processor.

17. The system of claim 15, wherein the exhaust gas recirculation valve is shut off when a temperature within the fuel processor reaches a predetermined temperature.

18. A system for producing electricity from fuel, the system comprising:
a fuel processor, the fuel processor producing hydrogen-containing reformate usable in a fuel cell stack;
sources of fuel, water, and air;
a fuel cell stack, the fuel cell stack having anode and cathode compartments;
a combustor that produces a combustor exhaust stream;
means for sending at least a portion of an oxygen-containing cathode exhaust stream to the combustor;
means for condensing water and storing water; and
a blower on an exhaust line from the combustor and creating an induction force to mobilize fluids in the system.

19. A method for producing electricity from fuel, comprising:
at a fuel processor, producing hydrogen-containing reformate usable in a fuel cell stack;
providing the reformate to a fuel cell stack to produce electricity and an oxygen-containing cathode exhaust stream; and
providing a first portion of an oxygen-containing cathode exhaust stream to a combustor to produce high-temperature exhaust, and a second portion of the oxygen-containing cathode exhaust stream as an input to the fuel processor.

20. The method of claim 19, further comprising providing hydrogen-containing anode exhaust to the combustor.

21. The method of claim 19, further comprising injecting cooling water directly into the cathode compartments of the fuel cell stack to remove reaction heat.

22. The method of claim 19, further comprising injecting cooling water directly into the anode compartments of the fuel cell stack to remove reaction heat.

23. The method of claim 19, further comprising injecting cooling water directly into the anode and cathode compartments of the fuel cell stack to remove reaction heat

24. A method of operating a system as described in claim 12, comprising:
providing an oxidant stream, a fuel stream, and steam to the inlet of the fuel processor during startup;
monitoring the temperature of the steam reforming reaction zone; and
shutting off said oxidant stream to the inlet of fuel processor when the temperature of the stream reforming reaction zone reaches a predetermined temperature.
